(19) United States
(12) Patent Application Publication
(10) Pub. No.: US 2009/0250178 A1
(43) Pub. Date: Oct. 8, 2009

(54) Vertical blind hanger pin

(76) Inventor: Jacob Ganzi, Kfar Neter (IL)

Correspondence Address: DAY PITNEY LLP, 7 TIMES SQUARE, NEW YORK, NY, 10036-7311, US

(21) Appl. No.: 12/322,691

(22) Filed: Feb. 5, 2009

Related U.S. Application Data
(60) Provisional application No. 61/065,032, filed on Feb. 8, 2008.

(51) Int. Cl. E06B 9/00

(52) U.S. Cl. 160/368.1

(57) ABSTRACT

A carrier for a vertical vane in a vertical blind includes a hanger pin holder and a hanger pin. The hanger pin holder includes a longitudinal bore and an opening communicating through a wall of the hanger pin holder to the longitudinal bore. The hanger pin has an upper section and a lower section. The upper section is inserted within the longitudinal bore and has a resilient prong having a catch and a projection. The catch retains the upper section within the longitudinal bore by lodging within the opening. The projection, which is below the hanger pin holder and outside the carrier, may be depressed to free the catch from the opening and permit the hanger pin to be removed from the hanger pin holder.

### CROSS REFERENCE TO RELATED APPLICATION

This application is based on U.S. Patent Application Ser. No. 61/065,032, filed Feb. 8, 2008, a provisional application upon which a claim for priority in the present application is based.

### BACKGROUND OF THE INVENTION

1. Field of the Invention

The present invention relates to vertical blinds for architectural openings. More specifically, the present invention relates to the hanger pins used to suspend vertical vanes from carriers in a vertical blind.

2. Description of the Prior Art

Vertical blinds are well known in the art. Generally, they include carriers from which vertical vanes are suspended. The vertical vanes are attached to the carriers by carrier pins, which are rotated by appropriate mechanisms to open and close the vertical blind. Carrier pins have been relatively fragile and easily broken.

Heretofore, the carrier pins have been of a design not permitting their easy removal from the carriers. For this reason, they have not been easy to replace when broken, and, often, the entire headrail for the vertical blind must be taken down to gain access to a pin needing replacement.

The present invention provides a solution to this problem which has long vexed those in the vertical blind industry.

### SUMMARY OF THE INVENTION

Accordingly, the present invention is an improvement for a vertical blind comprising a hanger pin holder and a hanger pin for carriers of the vertical vanes.

The hanger pin holder is substantially enclosed within the carrier. The hanger pin holder has a longitudinal axis and is rotatable about the longitudinal axis. Further, the hanger pin holder has a longitudinal bore and an opening communicating through a wall of the hanger pin holder to the longitudinal bore.

The hanger pin has an upper section and a lower section. The upper section is inserted within the longitudinal bore of the hanger pin holder and has a resilient prong. The resilient prong has a length, a catch at a point along the length, and a projection at an end of the resilient prong. The catch and the projection extend outwardly from the upper section.

The catch retains the upper section of the hanger pin within the longitudinal bore of the hanger pin holder by lodging within the opening through the wall thereof when the upper section is inserted into the longitudinal bore. The projection is outside the hanger pin holder and below the carrier so that the projection may be depressed to free the catch from the opening to permit the hanger pin to be withdrawn from the longitudinal bore.

The lower section of the hanger pin includes a gap and an upwardly oriented hook within the gap for suspending a vertical vane therefrom.

The present invention will now be described in more complete detail with frequent reference being made to the drawings identified below.

### BRIEF DESCRIPTION OF THE DRAWINGS

FIG. 1 is a side view of a carrier for a vane in a vertical blind;

FIG. 2 is a side view of a hanger pin for a vertical vane;

FIG. 3 is a cross-sectional view taken as indicated in FIG. 2;

FIG. 4 is a top view of the hanger pin;

FIG. 5 is a side view of a hanger pin holder;

FIG. 6 is a cross-sectional view taken as indicated in FIG. 5; and

FIG. 7 is a cross-sectional view taken as indicated in FIG. 6.

### DETAILED DESCRIPTION OF THE PREFERRED EMBODIMENT

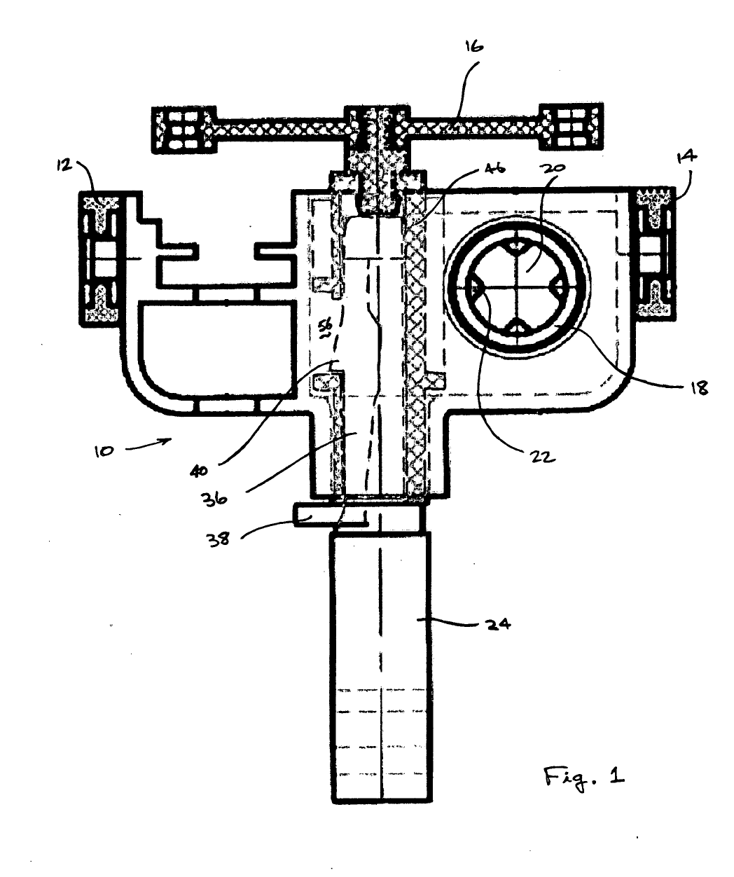

Turning now more particularly to these figures, FIG. 1 is a side view of a carrier 10 for a vane of a vertical blind for an architectural opening, such as a door or window. Elements within the carrier 10 relating to the present invention are depicted using phantom lines and will be described in detail below.

The carrier 10 includes guides 12, 14 which in use are disposed in channels on the inside surfaces of the front and rear of a headrail for the vertical blind. Carrier 10 slides across the headrail, with the guides 12, 14 sliding within the channels, to some extent when the vertical blind is moved across the architectural opening.

Successive carriers 10 in the vertical blind may be linked to one another using scissor elements, such as scissor element 16 shown in FIG. 1, which form a pantograph, maintaining the successive carriers 10 at uniform separations from one another as they are being moved across the architectural opening and enabling the successive carriers 10 to be moved in unison.

Also of interest is a rotatable element 18 disposed through the carrier 10. Although not shown in FIG. 1, rotatable element 18 is essentially a worm gear, which, when operated by rotating element 18, turns the vertical vane suspended from carrier 10 about a vertical axis, as occurs when the vertical blind is opened or closed. It will be noted that rotatable element 18 has a passage 20 whose inner surface has a plurality of longitudinal ridges 22. In a complete vertical blind, not shown in the accompanying figures, a notched rod, running the length of the headrail, passes through the passage 20 in each of the carriers 10. When the notched rod is rotated by the appropriate and customary mechanisms, which will not be described here, the ridges 22, disposed in the notches running along the rod, enable the rotatable element 18 to be rotated when the notched rod is rotated, in turn simultaneously opening or closing the vertical vanes of the vertical blind.

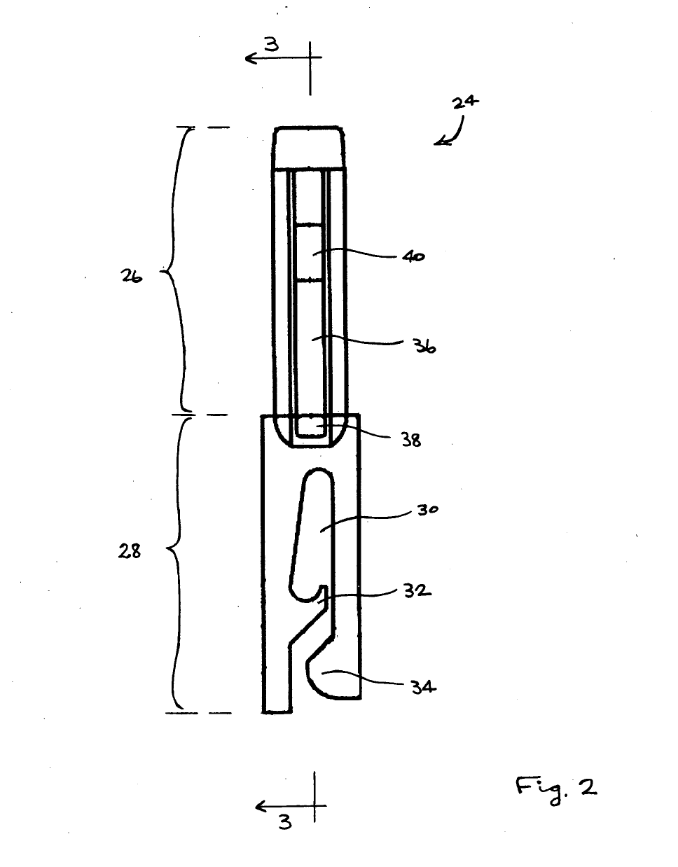

Referring now to FIG. 2, hanger pin 24 has an upper section 26 and a lower section 28. Upper section 26, as will be described below, is disposed within carrier 10 in FIG. 1. In the side view of the hanger pin 24 shown in FIG. 2, the lower section 28 includes a gap 30 with an upwardly oriented hook 32 therewithin and a narrowed opening formed by lip 34. In practice, a vertical vane to be suspended from the hanger pin 24 has a hole at its top end. When the top end of the vertical vane is inserted a sufficient distance into the gap 30, hook 32 engages the hole and prevents the vertical vane from being easily removed from the hanger pin 24.

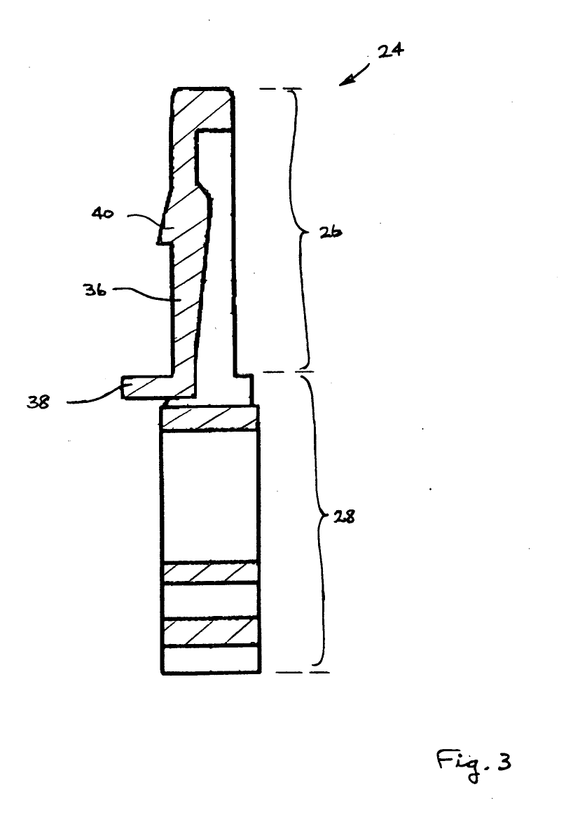

FIG. 3 is a cross-sectional view taken as indicated in FIG. 2. Of note for the present discussion is the central prong 36 in the upper section 26 of the hanger pin 24. At the bottom of the prong 36 is a projection 38 which may be depressed, or moved to the right in FIG. 3, to resiliently move the prong 36 in that direction. About midway up the prong 36 from the projection 38 is a catch 40, whose function will be described below. As shown most clearly in FIG. 2, prong 36 is movable between fixed vertical members 42, which are integrally connected to the lower section 28 of the hanger pin 24.

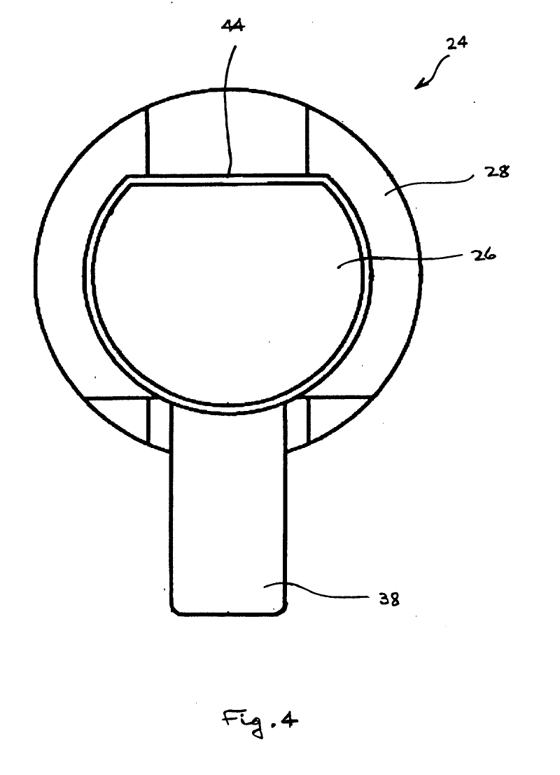

FIG. 4 is a top view of the hanger pin 24. Projection 38 extends outward from the hanger pin 24. Upper section 26 is of generally smaller diameter than lower section 28. Upper section 26 has a generally cylindrical shape except for a flattened surface 44 on the side opposite to the projection 38.

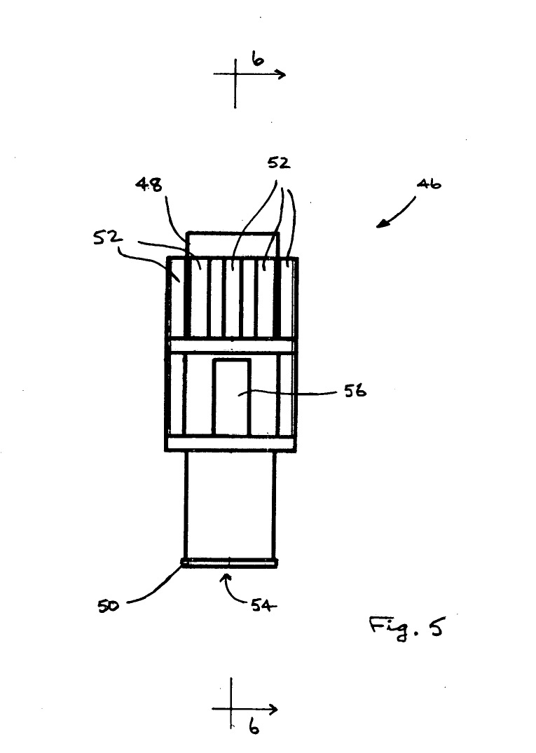

Referring now to FIG. 5, which is a side view of a hanger pin holder 46, the hanger pin holder 46 is disposed largely within the carrier 10 of FIG. 1, except for upper end 48 and lower end 50. The outer surface of the hanger pin holder 46 has a plurality of longitudinal cogs 52, which engage with the worm gear mentioned above to enable the hanger pin holder to be rotated about a longitudinal axis.

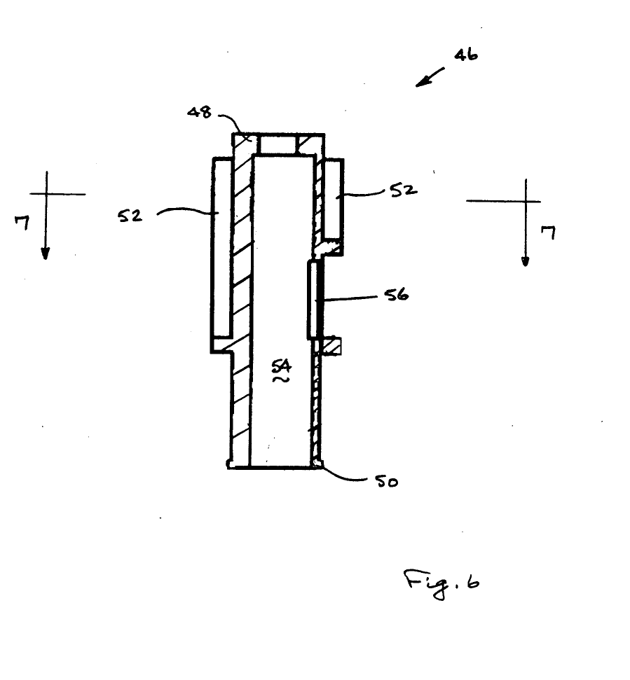

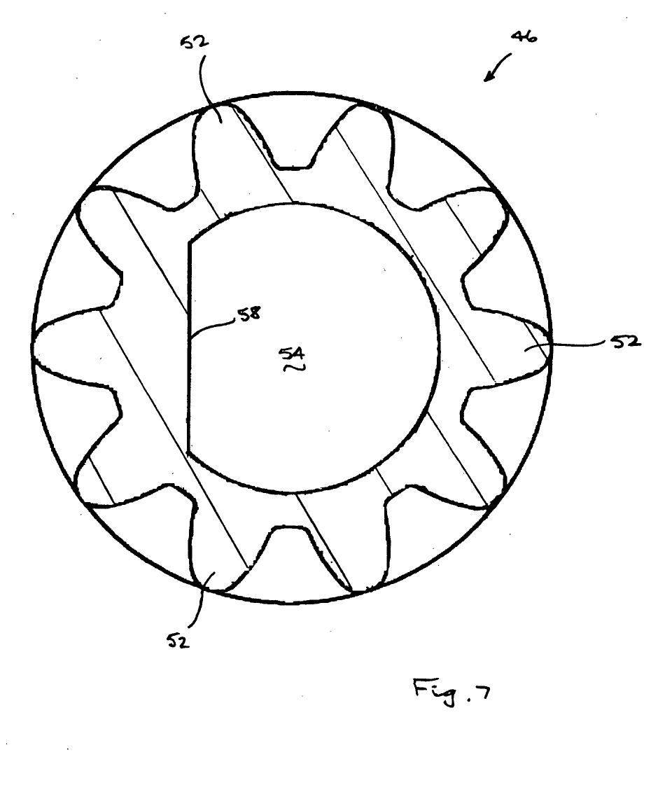

Hanger pin holder 46 has a longitudinal bore 54 and an opening 56 through its outer wall to the longitudinal bore 54. FIG. 6 is a cross-sectional view taken as indicated in FIG. 5 and illustrates the longitudinal bore 54 and the manner in which opening 56 communicates therewith. FIG. 7 is a cross-sectional view taken as indicated in FIG. 6 showing that longitudinal bore 54 is of an essentially cylindrical shape except for a flattened section 58 opposite to opening 56. The resulting shape of the longitudinal bore 54 corresponds to that of the upper section 26 of the hanger pin 24, and ensures that the hanger pin 24 can be inserted into and fixed within the hanger pin holder 46 in a desired orientation.

Now, turning back to FIG. 1, hanger pin holder 46, as stated above, is disposed largely within carrier 10. Hanger pin 24 fits within the longitudinal bore of hanger pin holder 46, and catch 46 rests upon the lower edge of opening 56 preventing the removal of the hanger pin 24 therefrom. However, by pushing or depressing the projection 38 toward the right in FIG. 1, the catch 40 may be moved sufficiently to permit it to clear the lower edge of the opening 56, thereby allowing the hanger pin 24 to be removed and easily replaced.

The hanger pin and hanger pin holder may, for example, be molded from a synthetic polymeric resin, that is, plastic, material.

Modifications to the above would be obvious to those of ordinary skill in the art, but would not bring the invention so modified beyond the scope of the appended claims.

What is claimed is:

1. In a carrier for a vane in a vertical blind, the improvement comprising:
a hanger pin holder, said hanger pin holder being substantially enclosed within said carrier, said hanger pin holder having a longitudinal axis and being rotatable about said longitudinal axis, said hanger pin holder further having a longitudinal bore and an opening communicating through a wall of said hanger pin holder to said longitudinal bore; and
a hanger pin, said hanger pin having an upper section and a lower section, said upper section being insertable within said longitudinal bore of said hanger pin holder and having a resilient prong; said resilient prong having a length, a catch at a point along said length, and a projection at an end thereof, said catch and said projection extending outwardly from said upper section; said catch retaining said upper section of said hanger within said longitudinal bore of said hanger pin holder by lodging within said opening through said wall thereof when said upper section is inserted into said longitudinal bore, and said projection being outside said hanger pin holder and below said carrier so that said projection may be depressed to free said catch from said opening to permit said hanger pin to be withdrawn from said longitudinal bore; and said lower section including a gap and an upwardly oriented hook within said gap for suspending a vertical vane from said hanger pin.

2. The improvement as claimed in claim 1 wherein said upper section of said hanger pin is of a substantially cylindrical shape having a portion with a flattened surface, and wherein said longitudinal bore of said hanger pin holder has a flattened section corresponding to said portion of said upper section of said hanger pin, so that said hanger pin can be inserted into and fixed within said hanger pin holder in a desired orientation.

3. The improvement as claimed in claim 2 wherein said portion of said upper section of said hanger pin with said flattened surface is on a side opposite to said projection, and wherein said flattened section of said longitudinal bore of said hanger pin holder is opposite to said opening.

4. The improvement as claimed in claim 1 wherein said hanger pin holder has an outer surface, said outer surface having a plurality of longitudinal cogs, so that a worm gear disposed in said carrier may rotate said hanger pin holder about said longitudinal axis, thereby rotating a vertical vane suspended from said hanger pin.

5. The improvement as claimed in claim 1 wherein said gap in said lower section of said hanger pin has a narrowed opening below said upwardly oriented hook, said narrowed opening being formed by a lip on one side of said gap.

6. The improvement as claimed in claim 1′ wherein said hanger pin holder and said hanger pin are molded from a plastic material.
